(19) United States
(12) Patent Application Publication
(10) Pub. No.: US 2016/0014619 A1
(43) Pub. Date: Jan. 14, 2016

(54) MULTIPLE CELL JOINT DETECTION AND INTERFERENCE CANCELLATION

(71) Applicant: QUALCOMM Incorporated, San Diego, CA (US)

(72) Inventors: Ming KANG, San Diego, CA (US); Wanlun Zhao, San Diego, CA (US); Insung Kang, San Diego, CA (US); Farrokh Abrishamkar, San Diego, CA (US)

(21) Appl. No.: 14/523,555

(22) Filed: Oct. 24, 2014

Related U.S. Application Data
(60) Provisional application No. 62/022,351, filed on Jul. 9, 2014.

(51) Int. Cl. H04W 24/02

(52) U.S. Cl. CPC H04W 24/02

(57) ABSTRACT

Methods and apparatus for managing interference are described and may include updating a covariance inverse value of a linear function to remove an effect on the linear function of a first set of channels associated with a first network entity, wherein the first set of channels are cancelled in response to performing a first cancellation procedure. Methods and apparatus for managing interference may further include performing a second cancellation procedure to cancel a second set of channels associated with a second network entity based at least in part on the updated covariance inverse value of the linear function.

### CLAIM OF PRIORITY

The present application for patent claims priority to Provisional Application No. 62/022,351 entitled “MULTIPLE CELL JOINT DETECTION AND INTERFERENCE CANCELLATION” filed Jul. 9, 2014, which is assigned to the assignee hereof and hereby expressly incorporated by reference herein.

### BACKGROUND

Aspects of the present disclosure relate generally to wireless communication systems, and more particularly, to multiple cell and interference cancellation.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, poor interference detection and cancellation techniques may lead to failures in establishing or maintaining a network connection. As a result, such failures may result in significant degradations in wireless communication performance and quality. Further, in such scenarios, limitations may exist in remedying the degradations. Thus, improvements in interference detection and cancellation are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of managing interference includes updating a covariance inverse value of a linear function to remove an effect on the linear function of a first set of channels associated with a first network entity, wherein the first set of channels are cancelled in response to performing a first cancellation procedure; and performing a second cancellation procedure to cancel a second set of channels associated with a second network entity based at least in part on the updated covariance inverse value of the linear function.

In a further aspect, a computer-readable medium storing computer executable code includes code executable to update a covariance inverse value of a linear function to remove an effect on the linear function of a first set of channels associated with a first network entity, wherein the first set of channels are cancelled in response to performing a first cancellation procedure; and code executable to perform a second cancellation procedure to cancel a second set of channels associated with a second network entity based at least in part on the updated covariance inverse value of the linear function.

In another aspect, an apparatus for managing interference includes means for updating a covariance inverse value of a linear function to remove an effect on the linear function of a first set of channels associated with a first network entity, wherein the first set of channels are cancelled in response to performing a first cancellation procedure; and means for performing a second cancellation procedure to cancel a second set of channels associated with a second network entity based at least in part on the updated covariance inverse value of the linear function.

In an additional aspect, an apparatus for managing interference includes an interference management component configured to update a covariance inverse value of a linear function to remove an effect on the linear function of a first set of channels associated with a first network entity, wherein the first set of channels are cancelled in response to performing a first cancellation procedure; and a cancellation procedure component configured to perform a second cancellation procedure to cancel a second set of channels associated with a second network entity based at least in part on the updated covariance inverse value of the linear function.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a user equipment that may detect and cancel at least one channel associated with a network entity in accordance with an aspect of the present disclosure, e.g., according to the interference management component;

FIG. 2 is a flowchart of an aspect of managing interference in accordance with an aspect of the present disclosure, e.g., according to FIG. 1;

FIG. 3 is a flowchart of another aspect of managing interference in accordance with an aspect of the present disclosure, e.g., according to FIG. 1;

FIG. 4 is a block diagram conceptually illustrating an example of a wireless communication system communication in accordance with an aspect of the present disclosure, e.g., according to FIG. 1;

FIG. 5 is a block diagram conceptually illustrating an example of a frame structure in a wireless communication system communication in accordance with an aspect of the present disclosure, e.g., according to FIG. 1; and

FIG. 6 is a block diagram conceptually illustrating an example of the network entity in communication with the user equipment in a wireless communication system and communication in accordance with an aspect of the present disclosure, e.g., according to FIG. 1.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details.

The present aspects generally relate to interference detection and cancellation in a wireless communication system. Specifically, user equipments (UEs) in some wireless communication networks (e.g., TD-SCDMA) may often experience interference from neighboring cells while camped on or in an active state with a serving cell. In such scenarios, the interfering cells may often exhibit stronger signal strength and/or coverage (e.g., higher transmit power). As such, accurate identification and/or detection and subsequent cancellation and/or mitigation of the interfering cells may provide improved demodulation performance at the UE, thereby resulting in a higher data rate/throughput, a decreased number of retransmissions, and improved radio communication quality.

The present methods and apparatus may provide an efficient solution, as compared to current solutions, to detect and cancel interfering cells. In an aspect, the present aspects may provide an apparatus and methods for detecting and canceling interfering signals from one or more neighboring cells. Specifically, the present aspects may, in a non-linear manner, detect and rank one or more interfering cells based on a power measurement value associated with each one of the one or more cells. Further, the present aspects may demodulate signals received from a highest ranked cell using a linear function. In addition, the present aspects may perform a first cancellation procedure to cancel a first of channels associated with the highest ranked cell based at least in part on the demodulated signals.

The present aspects may further update a covariance value of the linear function to remove the first set of canceled channels. The update may be performed with a low-complexity per code operation to directly remove a canceled channel's contribution or influence from the covariance value. Accordingly, a complete redetermination or recalculation of the covariance value may be avoided. Moreover, the present aspects may perform a second cancellation procedure to cancel a second set of channels of a second ranked cell based on demodulating signals received from the second ranked cell using the updated covariance value of the linear function. As such, the present aspects provide a non-linear approach to the detection and cancellation of interfering cells.

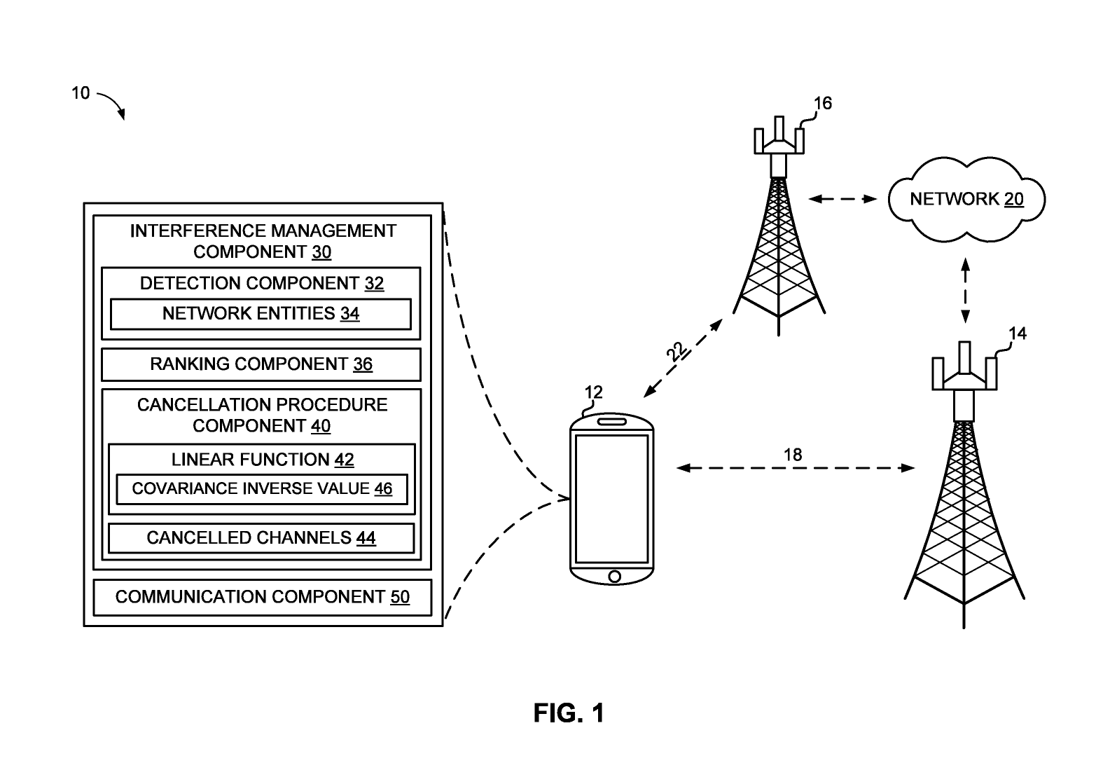

Referring to FIG. 1, in an aspect, a wireless communication system 10 may include at least one UE 12 in communication coverage of at least a first network entity 14 (e.g., base station including one or more cells) and a second network entity 16 (e.g., base station including one or more cells). UE 12 may communicate with network 20 via, for example, one or both of first network entity 14 and second network entity 16. In some aspects, multiple UEs including UE 12 may be in communication coverage with one or more network entities, including first network entity 14 and second network entity 16.

In an example, UE 12 may transmit and/or receive wireless communication to and/or from first network entity 14 via one or more communication channels 18, utilizing one or more radio access technologies (RATs) such as, but not limited to, TD-SCDMA. Additionally, UE 12 may transmit and/or receive wireless communication to and/or from second network entity 16 via one or more communication channels 22, utilizing one or more radio access technologies (RATs) such as, but not limited to, TD-SCDMA. Further, first network entity 14 and/or second network entity 16 may include one or more cells providing communication coverage to UEs. In the aspects described herein, the first network entity 14, second network entity 16 and/or the one or more cells associated with each of the first network entity 14 and the second network entity 16 may be referred to as a network entity.

Such wireless communications may include, but are not limited to, information relating to the formation of, or used for the detection and/or determination of, interference caused by or experienced from one or more channels from one or both of the first network entity 14 and second network entity 16. Additionally, in such aspects, one or more components and/or subcomponents of UE 12, such as a communication component 50, may operate or otherwise communicate based on information determined at UE 12 by interference management component 30. As used herein, the term “component” includes one of the parts that make up a system or device, such as UE 12; and, a component may be hardware or software and may be subdivided into other components.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for the Internet-of-Things, or some other suitable terminology.

Additionally, first network entity 14 and second network entity 16 may be a macrocell, small cell, picocell, femtocell, relay, Node B, mobile Node B, an evolved Node B, UE (e.g., communicating in peer-to-peer or ad-hoc mode with UE 12), or substantially any type of component that can communicate with UE 12 to provide wireless network access and/or coverage at the UE 12.

As noted above, according to the present aspects, UE 12 may include interference management component 30, which may include various components and/or subcomponents configured to detect one or more potentially interfering network entities and cancel at least one channel associated with the cell based on executing a linear function. Specifically, interference management component 30 may be configured to detect and cancel interference caused by or experienced from one or more network entities (e.g., one or more cells of first network entity 14 and/or second network entity 16) in a non-linear manner such that cancelled channels associated with a detected network entity (e.g., first network entity 14) exhibiting strong interference may be removed from a subsequent performance of the cancellation procedure for a subsequent network entity (e.g., second network entity 16). As such, the effect or contribution of the channels cancelled following a performance of a cancellation procedure (e.g., for a first network entity 14) may be removed from consideration for a subsequent performance of the cancellation procedure for a subsequent network entity (e.g., second network entity 16).

Further, interference management component 30 may be configured to detect and cancel interference in sequential and/or hierarchical manner such that network entities exhibiting the highest interference may be cancelled initially. Accordingly, interference management component 30 may be configured to cancel interfering channels associated with one or more network entities non-linearly by removing the effect of the cancelled channels associated with the strongest network entities from a covariance inverse value of a linear function in subsequent interference cancellation procedures.

In an aspect, interference management component 30 may include detection component 32, which may be configured to detect one or more network entities 34 providing communication coverage for UE 12. For example, detection component 32 may be configured to detect one or both of first network entity 14 and second network entity 16, which form the detected network entities 34 (e.g., which may take the form a list). Additionally, detection component 32 may be configured to detect the one or more network entities 34 based on the transmit or output power of the network entities 34. For instance, detection component 32 may detect first network entity 14 and second network entity 16 based on a power measurement value corresponding to each one of the network entities 34.

Examples of the power measurement value include, but are not limited to, a total power value, a power concentration value, a received signal strength indicator (RSSI), and received signal code power (RSCP). For instance, RSSI may be a measurement defined as the total received wideband power observed by a UE (e.g., UE 12) from all sources, including co-channel serving and non-serving cells, adjacent channel interference and thermal noise within the measurement bandwidth. Further, for example, RSCP may be a technology specific measurement which provides a cell-specific signal strength metric. Additionally, the RSCP of a network entity may be used or defined as the linear average over the power contributions (in Watts) of the Resource Elements (REs) which carry cell-specific RS within the considered measurement bandwidth.

In addition, interference management component 30 may include ranking component 36, which may be configured to rank the detected network entities 34 based on a power measurement value associated with each of the detected network entities 34. In such aspect, ranking may produce an ordering of the detected network entities 34, with those having higher power measurement value having a higher ranking than those having a lower power measurement value. For example, UE 12 may detect both first network entity 14 and second network entity 16. In such an example, UE 12 may detect a first power measurement value corresponding to the first network entity 14 and a second power measurement value corresponding to the second network entity 16. Further, ranking component 36 may be configured to rank the first network entity 14 and the second network entity 16 based at least in part on the first power measurement value associated with the first network entity 14 and the second power measurement value associated with the second network entity 16.

In some aspects, the first power measurement value may be greater than the second power measurement value. As such, in such aspects, the first network entity 14 may exhibit a highest output power and the second network entity 16 may exhibit a subsequent highest output power among the detected network entities 34. Accordingly, interference management component 30 may provide the appropriate network entity for which a cancellation procedure may be performed to the cancellation procedure component 40 and based on the ranking of the one or more network entities 34 by the ranking component 36. In such aspects, as the first network entity 14 exhibits the highest interfering characteristics (e.g., output power), cancellation procedure component 40 may received or otherwise be provided with the information relating to the first network entity 14.

Further, interference management component 30 may include cancellation procedure component 40, which may be configured to perform an interference cancellation procedure for cancelling interference caused by or experienced from a network entity. For example, cancellation procedure component 40 may be configured to perform a cancellation procedure on or using information from first network entity 14, which may be exhibiting the highest potential interference in the form of output power.

Specifically, cancellation procedure component 40 may be configured to demodulate signals received from the first network entity 14 using a linear function 42 including covariance inverse value 46, at which point in time may be an original covariance inverse value. In some aspects, the linear function 42 may include a linear minimum mean square estimation function. In such aspect, the covariance inverse value 46 may be part of the linear function 42. As such, the linear function 42 may project the received signal to the direction that the output signal such that the interference and noise ratio is maximisd among each and every linear function. Accordingly, after each cancellation procedure is preformed, the covariance inverse value 46 may be updated to adjust the linear function 42 such that it may be an optimum with respect to the post-canceled remaining signals.

Further, cancellation procedure component 40 may be configured to perform the first cancellation procedure to cancel the first set of channels associated with the first network entity 14 based at least in part on the demodulated signals. In other words, first network entity 14, which may include one or more cells providing communication coverage to UE 12, may exhibit, interference on the one or more communication channels 18. In these aspects, UE 12 may be camped on or is actively served by another cell on first network entity 14 or by second network entity 16.

In particular, to perform the cancellation procedure, which in the aspect of the first network entity 14 may be a first cancellation procedure, cancellation procedure component 40 may be configured to determine a symbol modulation type and a demodulation quality value using the demodulated signals from the first network entity 14. For example, the symbol modulation type may be one of quadrature phase shift keying (QPSK) or quadrature amplitude modulation (QAM). In some aspects, QPSK may be a modulation scheme in which information is conveyed through phase variations of a carrier, while keeping a constant amplitude and frequency. In other aspects, QAM may involve modulating the amplitude of two separate carrier waves, exactly 90 degrees out of phase with each other (e.g., sine and cosine). Accordingly, cancellation procedure component 40 may be configured to identify at least one channel (e.g., among the one or more communication channels 18) associated with the first network entity 14 exhibiting potential interfering characteristics.

Additionally, cancellation procedure component 40 may be configured to determine whether the demodulation quality associated with the at least one channel meets or exceeds a channel quality threshold value. For example, cancellation procedure component 40 may determine the quality of the channel by comparing the demodulation quality, which may be represented as or indicative of a signal-to-noise ratio to the channel quality threshold value. Cancellation procedure component 40 may be configured to suppress or prevent the cancellation of the at least one channel when the demodulation quality does not meet or exceed the channel quality threshold value.

Otherwise, cancellation procedure component 40 may be configured to determine whether the symbol modulation type associated with the at least one channel satisfies a modulation classification condition. For example, in some aspects, cancellation procedure component 40 may be configured to compare the symbol modulation type relating to a symbol type associated with a modulation scheme to the modulation classification condition relating to one or both of QPSK and QAM. Further, cancellation procedure component 40 may be configured to cancel the at least one channel based on determining that the symbol modulation type satisfies a modulation classification condition. The cancelled channels 44 may be updated to include the canceled channel associated with the first network entity 14.

As such, cancellation procedure component 40 may be configured to cancel only interfering signal power where symbol decisions relating to both the demodulating quality and the symbol modulation type may be reliably determined. In other aspects, the remaining interfering signals may be suppressed using the linear function.

In additional aspects, interference management component 30 may be configured to update covariance inverse value 46 of linear function 42 to remove an effect of a first set of channels associated with a first network entity 14. In some aspects, the first set of channels may be cancelled in response to performing a first cancellation procedure. For example, interference management component 30 may be configured to update the covariance inverse value 46 to remove from a subsequent calculation or consideration for a second or subsequent strongest network entity (e.g., second network entity 16) the cancelled channels 44 canceled based on performing the cancellation procedure for the first network entity 14. As such, the update may be performed with a low-complexity per code (e.g., OVSF) operation to directly remove a channel's contribution from the covariance inverse value 46. Accordingly, a complete recalculation of the covariance inverse value 46 may not be necessary.

Further, cancellation procedure component 40 may be configured to perform a second cancellation procedure to cancel a second set of channels associated with second network entity 16 based at least in part on the covariance inverse value, which may be an updated covariance inverse value, of the linear function 42. For example, aspects described herein with respect to the first cancellation procedure may be applied to the second cancellation procedure. Hence, cancellation procedure component 40 may be configured to perform similar determination as conducted with respect to the first cancellation procedure. However, the second cancellation procedure may perform such determinations based on the covariance inverse value 46, which is updated following the performance of the first cancellation procedure to remove the cancelled channels 44 from consideration in a subsequent determination of the linear function 42.

Moreover, in an alternative or additional aspect, UE 12 may include communication component 50 configured to facilitate or otherwise enable UE 12 to communicate with one or both of first network entity 14 via one or more communication channels 18 and second network entity 16 via one or more communication channels 22 according to or utilizing one or more RATs (e.g., TD-SCDMA). In such aspects, the one or more communication channels 18 and 22 may enable communication on both the uplink and downlink between UE 12 and first network entity 14.

In some aspects, communication component 50 may be configured to receive information relating to the detection or determination, of interference cancellation, for instance, relating to one or more communication channels of first network entity 14. Additionally, communication component 50 may includes a bus or other links to enable communication between the components of UE 112 and/or interference management component 30. In an example, aspects of the communication component 50 may be performed or implemented by a transmitter, receiver, and/or transceiver (not shown) in UE 12.

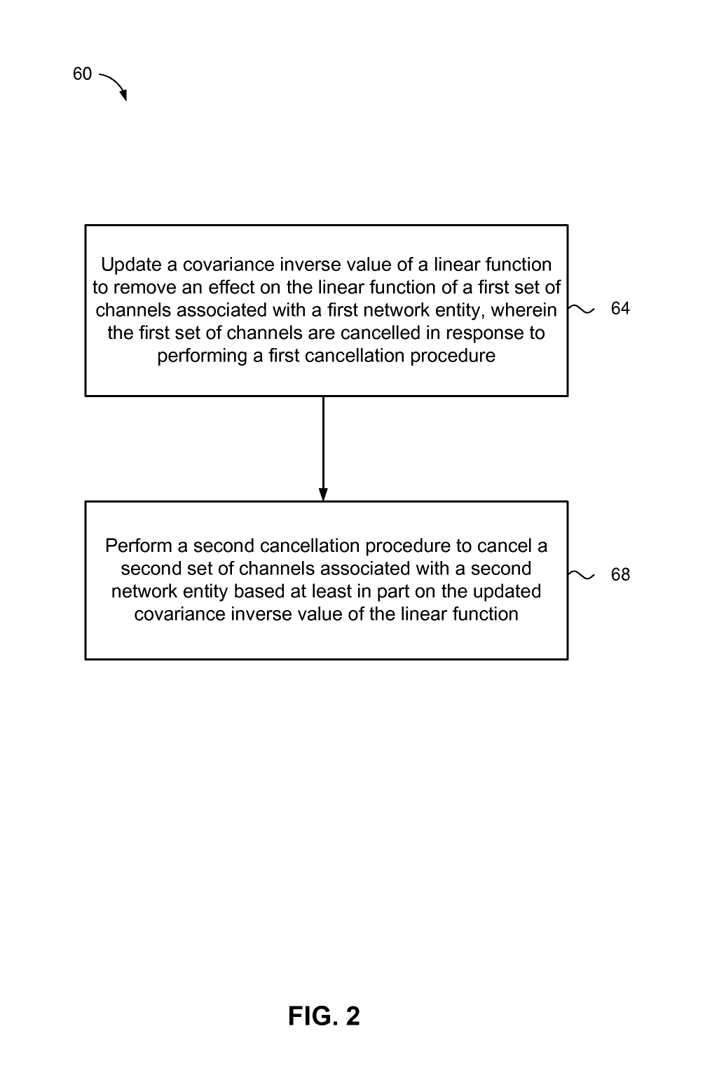

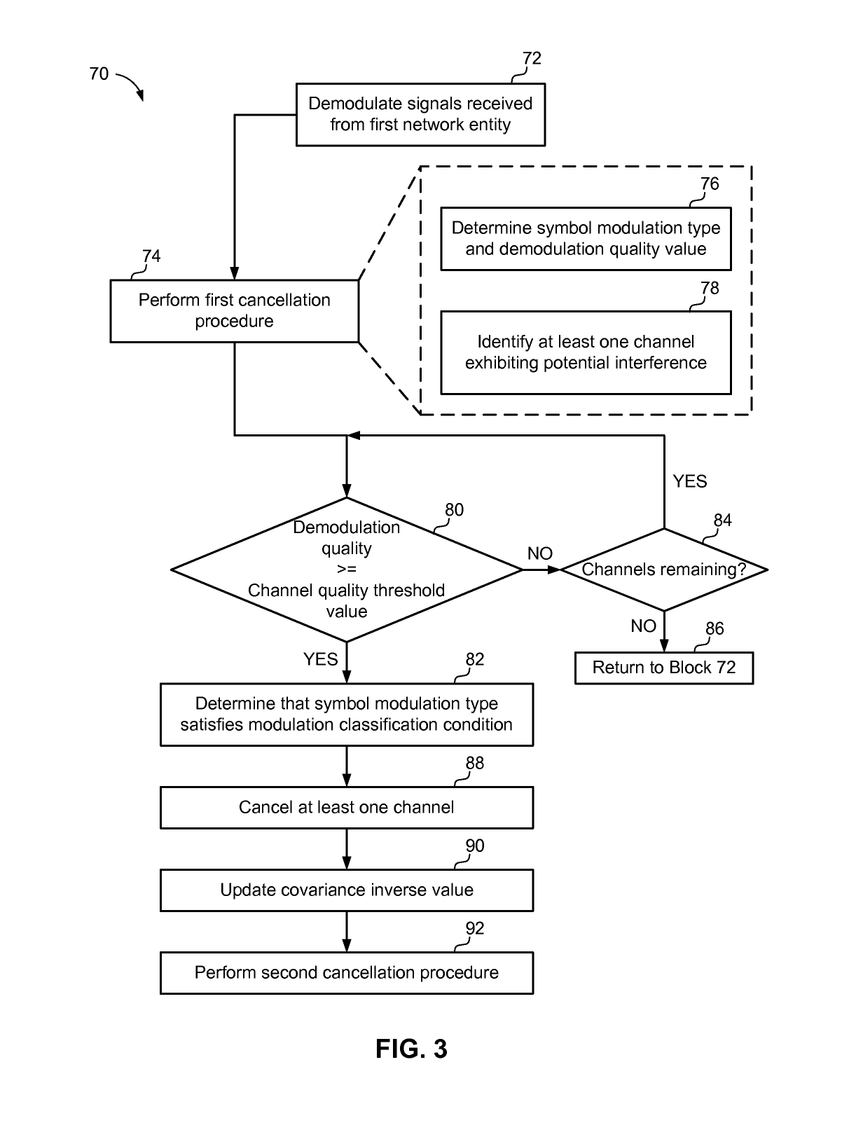

Referring to FIGS. 2 and 3, the method is shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 2, in operation, a UE such as UE 12 (FIG. 1) including interference management component 30 (FIG. 1) may perform one aspect of a method 60 for detecting one or more strong cells and mitigating the interference resulting from the detected cells by cancelling interfering channels associated with the detected cells. As described in further detail below, method 60 provides a process which may enhance interference management at a UE (e.g., UE 12, FIG. 1).

In an aspect, at block 64, method 60 may update a covariance inverse value of a linear function to remove an effect on the linear function of a first set of channels associated with a first network entity, wherein the first set of channels are cancelled in response to performing a first cancellation procedure. For example, as described herein, UE 12 (FIG. 1) may execute interference management component 30 (FIG. 1) to update a covariance inverse value 46 (FIG. 1) of a linear function 42 (FIG. 1) to remove an effect on the linear function of a first set of channels (e.g., cancelled channels aggregated within cancelled channels 44 (FIG. 1)) associated with a first network entity 14 (FIG. 1), wherein the first set of channels are cancelled in response to performing a first cancellation procedure.

Further, at block 68, method 60 may perform a second cancellation procedure to cancel a second set of channels associated with a second network entity based at least in part on the updated covariance inverse value of the linear function. For instance, as described herein, interference management component 30 (FIG. 1) may execute cancellation procedure component 40 (FIG. 1) to perform a second cancellation procedure to cancel a second set of channels (e.g., cancelled channels aggregated within cancelled channels 44 (FIG. 1)) associated with a second network entity 16 (FIG. 1) based at least in part on the updated covariance inverse value (e.g., covariance inverse value 46 continuously updated as channels are cancelled for a particular network entity and/or cell) of the linear function 42 (FIG. 1).

Referring to FIG. 3, in operation, a UE such as UE 12 (FIG. 1) including interference management component 30 (FIG. 1) may perform an aspect of a method 70 for detecting one or more strong cells and mitigating the interference resulting from the detected cells by cancelling interfering channels associated with the detected cells. As described in further detail below, method 70 provides a process which may enhance interference management at a UE (e.g., UE 12, FIG. 1).

Specifically, at block 72, method 70 may demodulate signals received from a first network entity. For example, UE 12 (FIG. 1) and/or interference management component 30 (FIG. 1) may execute cancellation procedure component 40 (FIG. 1) to demodulate signals received from the first network entity 14 (FIG. 1) using a linear function 42 (FIG. 1) including an original covariance inverse value 46 (FIG. 1).

At block 74, method 70 may perform a first cancellation procedure. For instance, UE 12 (FIG. 1) and/or interference management component 30 (FIG. 1) may execute cancellation procedure component 40 (FIG. 1) to perform the first cancellation procedure to cancel a first set of channels associated with the first network entity 14 (FIG. 1) based at least in part on the demodulated signals.

In some aspects, to perform the first cancellation procedure at block 74, method 70 may determine a symbol modulation type and a demodulation quality value at block 76. For example, UE 12 (FIG. 1) and/or interference management component 30 (FIG. 1) may execute cancellation procedure component 40 (FIG. 1) to determine a symbol modulation type and a demodulation quality value using the demodulated signals from the first network entity 14 (FIG. 1).

At block 78, to perform the first cancellation procedure at block 74, method 70 may further identify at least one channel exhibiting potential interference. For instance, UE 12 (FIG. 1) and/or interference management component 30 (FIG. 1) may execute cancellation procedure component 40 (FIG. 1) to identify at least one channel associated with the first network entity 14 (FIG. 1) exhibiting potential interfering characteristics.

Further, at block 80, method 70 may determine whether the demodulation quality meets or exceeds a channel quality threshold value. For instance, UE 12 (FIG. 1) and/or interference management component 30 (FIG. 1) may execute cancellation procedure component 40 (FIG. 1) to determine whether the demodulation quality associated with a channel meets or exceeds a channel quality threshold value. Method 70 may proceed to block 84 when the demodulation quality associated with the channel does meet or exceed a channel quality threshold value. At block 84, a determination may be made as to whether any channels remain that exhibit potential interference. If there are no channels remaining, at block 86, method 70 may return to block 72.

However, if at least one additional channel remains, method 70 may return to block 80, where a determination may be made as to whether the demodulation quality associated with another channel meets or exceeds a channel quality threshold value. Further, at block 82, method 70 may determine that the symbol modulation type satisfies a modulation classification condition, for example, when the demodulation quality associated with a channel meets or exceeds a channel quality threshold value. For instance, UE 12 (FIG. 1) and/or interference management component 30 (FIG. 1) may execute cancellation procedure component 40 (FIG. 1) to determine that the symbol modulation type satisfies a modulation classification condition.

As such, at block 88, method 70 may cancel at least one channel satisfying the conditions set forth at blocks 80 and 82. In other words, UE 12 (FIG. 1) and/or interference management component 30 (FIG. 1) may execute cancellation procedure component 40 (FIG. 1) to cancel the at least one channel based on determining that the symbol modulation type satisfies a modulation classification condition.

In addition, at block 90, method 70 may update a covariance inverse value. Specifically, for instance, UE 12 (FIG. 1) and/or interference management component 30 (FIG. 1) may execute cancellation procedure component 40 (FIG. 1) to update the covariance inverse value 46 (FIG. 1) of a linear function 42 (FIG. 1) to remove an effect on the linear function 42 of a first set of channels associated with the first network entity 14 (FIG. 1). In some aspects, the first set of channels are cancelled in response to performing a first cancellation procedure.

Moreover, at block 92, method 90 may perform a second cancellation procedure. For example, UE 12 (FIG. 1) and/or interference management component 30 (FIG. 1) may again execute cancellation procedure component 40 (FIG. 1) to cancel a second set of channels associated with a second network entity 16 (FIG. 1) based at least in part on the updated covariance inverse value 46 (FIG. 1) of the linear function 42 (FIG. 1). As such, rather than recalculating the covariance inverse value in its entirety, method 70 may advantageously remove an effect of interfering channels from one or more network entities from the demodulation at the UE.

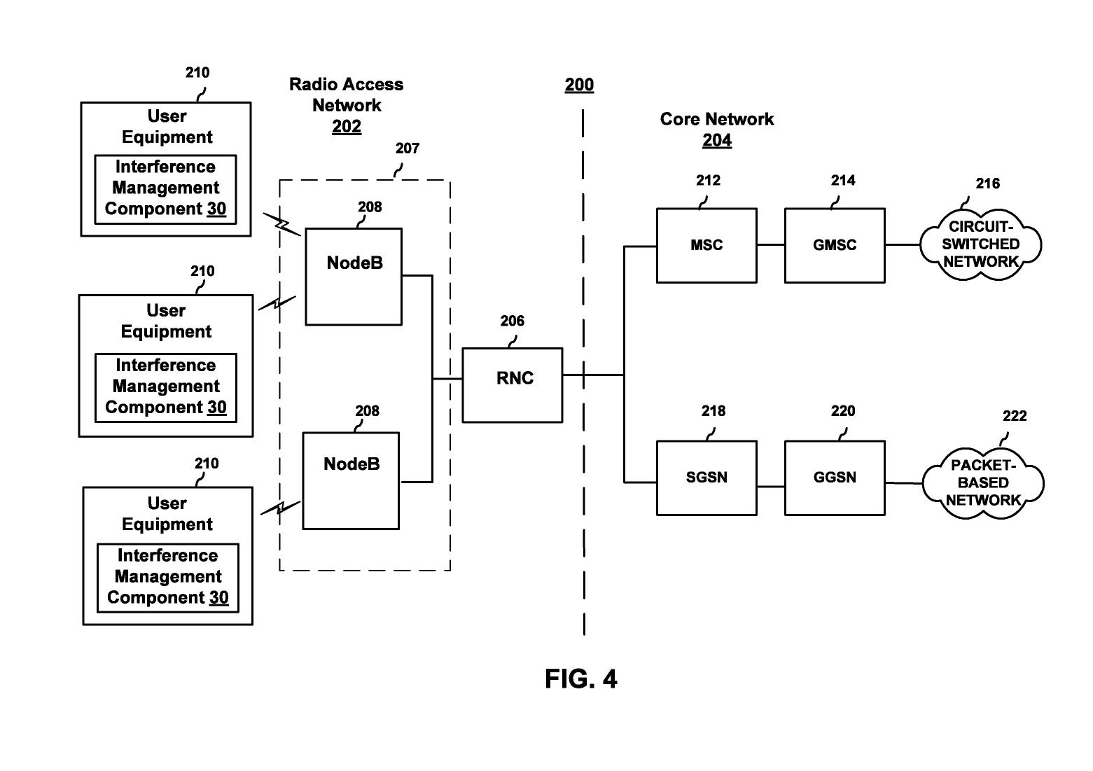

Turning now to FIG. 4, a block diagram is shown illustrating an example of a telecommunications system 200 in which UE 12 (FIG. 1) including interference management component 30 (FIG. 1), may operate, such as in the form of or as a part of UEs 210, and one or more Node Bs 208 may operate according to first network entity 14 (FIG. 1) and/or second network entity 16 (FIG. 1). The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services.

The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown, however, the RNS 207 may include any number of wireless Node Bs. The Node Bs 208 provide wireless access points to a core network 204 for any number of mobile apparatuses.

Initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208, each of which may include or otherwise be configured to operate according to the aspects described herein with respect to the interference management component 30 (FIG. 1). The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

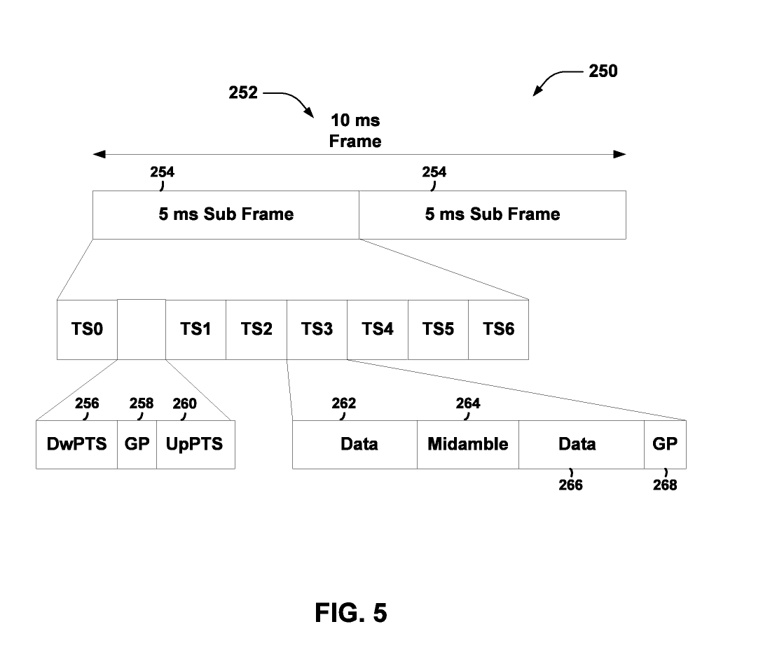

FIG. 5 illustrates one aspect of a frame structure 250 for a TD-SCDMA carrier, which may be used in communications between UE 12 (FIG. 1) including interference management component 30 (FIG. 1) and one or both of first network entity 14 (FIG. 1) and second network entity 16 (FIG. 1), as described herein. The TD-SCDMA carrier, as illustrated, has a frame 252 that may be 10 milliseconds (ms) in length. The frame 252 may have two 5 ms subframes 254, and each of the subframes 254 includes seven time slots, TS0 through TS6. The first time slot, TS0, may be allocated for inter/intra frequency measurements and/or downlink communication, while the second time slot, TS1, may be allocated for uplink communication.

The remaining time slots, TS2 through TS6, may be used for either uplink or downlink, which allows for greater flexibility during times of higher data transmission times in either the uplink or downlink directions. A downlink pilot time slot (DwPTS) 256, a guard period (GP) 258, and an uplink pilot time slot (UpPTS) 260 (also known as the uplink pilot channel (UpPCH)) are located between TS0 and TS1. Each time slot, TS0-TS6, may allow data transmission multiplexed on a maximum of, for instance, 16 code channels. Data transmission on a code channel includes two data portions 262 separated by a midamble 264 and followed by a guard period (GP) 268. The midamble 264 may be used for features, such as channel estimation, while the GP 268 may be used to avoid inter-burst interference.

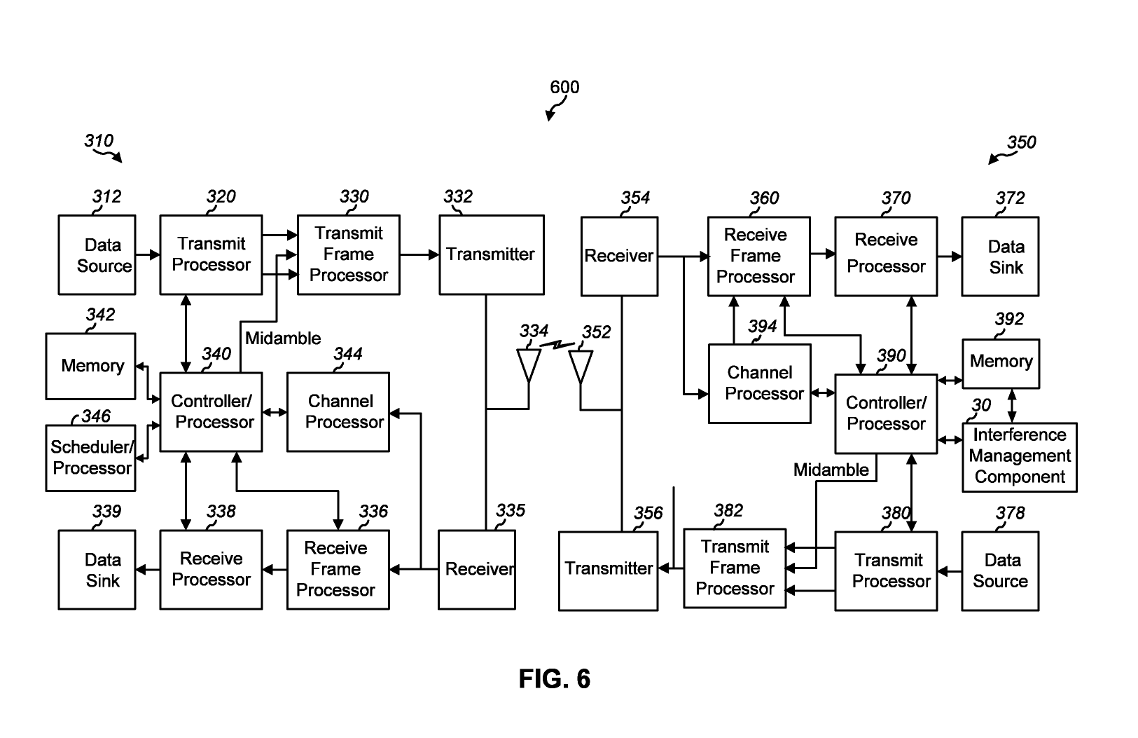

FIG. 6 is a block diagram of a Node B 310 in communication with a UE 350 in a RAN 300, where RAN 300 may be the same as or similar to RAN 202 in FIG. 3, the Node B 310 may be the same as or similar to Node B 208 in FIG. 3, where the UE 350 may be the same as or similar to UE 210 in FIG. 4 or the UE 12 including interference management component 30 (FIG. 1). In other aspects, UE 350 may include interference management component 30 (FIG. 1), and thereby may be configured to operate according to the aspects described herein with respect to thereof. In the downlink communication, a transmit processor 320 may receive data from a data source 312 and control signals from a controller/processor 340. The transmit processor 320 provides various signal processing functions for the data and control signals, as well as reference signals (e.g., pilot signals).

For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 264 (FIG. 5) from the UE 350. The symbols generated by the transmit processor 320 are provided to a transmit frame processor 330 to create a frame structure. The transmit frame processor 330 creates this frame structure by multiplexing the symbols with a midamble 264 (FIG. 5) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 264 (FIG. 5) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394.

The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols.

Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 264 (FIG. 5) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 264 (FIG. 5) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), unless the element is expressly recited using the phrase “means for” or, in the case of a method claim, the element is recited using the phrase “step for.”

1. A method of managing interference, comprising:
updating a covariance inverse value of a linear function to remove an effect on the linear function of a first set of channels associated with a first network entity, wherein the first set of channels are cancelled in response to performing a first cancellation procedure; and
performing a second cancellation procedure to cancel a second set of channels associated with a second network entity based at least in part on the updated covariance inverse value of the linear function.

2. The method of claim 1, further comprising:
demodulating signals received from the first network entity using the linear function including an original covariance inverse value; and
performing the first cancellation procedure to cancel the first set of channels associated with the first network entity based at least in part on the demodulated signals.

3. The method of claim 2, wherein performing the first cancellation procedure includes:
determining a symbol modulation type and a demodulation quality value using the demodulated signals from the first network entity; and
identifying at least one channel associated with the first network entity exhibiting potential interfering characteristics.

4. The method of claim 3, further comprising:
determining that the demodulation quality associated with the at least one channel meets or exceeds a channel quality threshold value;
determining that the symbol modulation type associated with the at least one channel satisfies a modulation classification condition; and
cancelling the at least one channel based on determining that the symbol modulation type satisfies a modulation classification condition, wherein the first set of channels includes the at least one channel.

5. The method of claim 3, wherein the symbol modulation type includes one of a quadrature phase shift keying (QPSK) scheme or a quadrature amplitude modulation (QAM) scheme, and wherein the demodulation quality value is indicative of a signal-to-noise ratio value.

6. The method of claim 1, wherein the linear function includes a minimum mean square estimation function.

7. The method of claim 1, wherein the first network entity exhibits a highest output power among one or more network entities and the second network entity exhibits a subsequent highest output power among the one or more network entities.

8. The method of claim 1, further comprising ranking the first network entity and the second network entity based at least in part on a power measurement value associated with each one of the first ranked network entity and the second network entity.

9. The method of claim 8, wherein the power measurement value includes one or both of a total power value and a power concentration value.

10. A computer-readable medium storing computer executable code, comprising:
code executable to update a covariance inverse value of a linear function to remove an effect on the linear function of a first set of channels associated with a first network entity, wherein the first set of channels are cancelled in response to performing a first cancellation procedure; and
code executable to perform a second cancellation procedure to cancel a second set of channels associated with a second network entity based at least in part on the updated covariance inverse value of the linear function.

11. The computer-readable medium of claim 10, further comprising:
code executable to demodulate signals received from the first network entity using the linear function including an original covariance inverse value; and
code executable to perform the first cancellation procedure to cancel the first set of channels associated with the first network entity based at least in part on the demodulated signals.

12. The computer-readable medium of claim 11, wherein the code executable to perform the first cancellation procedure includes:
code executable to determine a symbol modulation type and a demodulation quality value using the demodulated signals from the first network entity; and
code executable to identify at least one channel associated with the first network entity exhibiting potential interfering characteristics.

13. The computer-readable medium of claim 12, further comprising:
code executable to determine that the demodulation quality associated with the at least one channel meets or exceeds a channel quality threshold value;
code executable to determine that the symbol modulation type associated with the at least one channel satisfies a modulation classification condition; and
code executable to cancel the at least one channel based on determining that the symbol modulation type satisfies a modulation classification condition, wherein the first set of channels includes the at least one channel.

14. The computer-readable medium of claim 10, wherein the linear function includes a minimum mean square estimation function.

15. The computer-readable medium of claim 10, wherein the first network entity exhibits a highest output power among one or more network entities and the second network entity exhibits a subsequent highest output power among the one or more network entities.

16. An apparatus for managing interference, comprising:
means for updating a covariance inverse value of a linear function to remove an effect on the linear function of a first set of channels associated with a first network entity, wherein the first set of channels are cancelled in response to performing a first cancellation procedure; and
means for performing a second cancellation procedure to cancel a second set of channels associated with a second network entity based at least in part on the updated covariance inverse value of the linear function.

17. The apparatus of claim 16, further comprising:
means for demodulating signals received from the first network entity using the linear function including an original covariance inverse value; and
means for performing the first cancellation procedure to cancel the first set of channels associated with the first network entity based at least in part on the demodulated signals.

18. The apparatus of claim 17, wherein the means for performing the first cancellation procedure includes:
means for determining a symbol modulation type and a demodulation quality value using the demodulated signals from the first network entity; and
means for identifying at least one channel associated with the first network entity exhibiting potential interfering characteristics.

19. The apparatus of claim 18, further comprising:
means for determining that the demodulation quality associated with the at least one channel meets or exceeds a channel quality threshold value;
means for determining that the symbol modulation type associated with the at least one channel satisfies a modulation classification condition; and
means for cancelling the at least one channel based on determining that the symbol modulation type satisfies a modulation classification condition, wherein the first set of channels includes the at least one channel.

20. The apparatus of claim 16, wherein the linear function includes a minimum mean square estimation function.

21. The apparatus of claim 16, wherein the first network entity exhibits a highest output power among one or more network entities and the second network entity exhibits a subsequent highest output power among the one or more network entities.

22. An apparatus for managing interference, comprising:
an interference management component configured to update a covariance inverse value of a linear function to remove an effect on the linear function of a first set of channels associated with a first network entity, wherein the first set of channels are cancelled in response to performing a first cancellation procedure; and
a cancellation procedure component configured to perform a second cancellation procedure to cancel a second set of channels associated with a second network entity based at least in part on the updated covariance inverse value of the linear function.

23. The apparatus of claim 22, wherein the cancellation procedure component is further configured to:
demodulate signals received from the first network entity using the linear function including an original covariance inverse value; and
perform the first cancellation procedure to cancel the first set of channels associated with the first network entity based at least in part on the demodulated signals.

24. The apparatus of claim 23, wherein to perform the first cancellation procedure, the cancellation procedure component is further configured to:
determine a symbol modulation type and a demodulation quality value using the demodulated signals from the first network entity; and
identify at least one channel associated with the first network entity exhibiting potential interfering characteristics.

25. The apparatus of claim 24, wherein the cancellation procedure component is further configured to:
determine that the demodulation quality associated with the at least one channel meets or exceeds a channel quality threshold value;
determine that the symbol modulation type associated with the at least one channel satisfies a modulation classification condition; and
cancel the at least one channel based on determining that the symbol modulation type satisfies a modulation classification condition, wherein the first set of channels includes the at least one channel.

26. The apparatus of claim 24, wherein the symbol modulation type includes one of a quadrature phase shift keying (QPSK) scheme or a quadrature amplitude modulation (QAM) scheme, and wherein the demodulation quality value is indicative of a signal-to-noise ratio value.

27. The apparatus of claim 22, wherein the linear function includes a minimum mean square estimation function.

28. The apparatus of claim 22, wherein the first network entity exhibits a highest output power among one or more network entities and the second network entity exhibits a subsequent highest output power among the one or more network entities.

29. The apparatus of claim 22, further comprising a ranking component configured to rank the first network entity and the second network entity based at least in part on a power measurement value associated with each one of the first ranked network entity and the second network entity.

30. The apparatus of claim 29, wherein the power measurement value includes one or both of a total power value and a power concentration value.
